(19) United States
(12) Patent Application Publication
(10) Pub. No.: US 2016/0031410 A1
(43) Pub. Date: Feb. 4, 2016

(54) SEATBELT APPARATUS

(71) Applicant: Takata Corporation, Tokyo (JP)

(72) Inventor: Masahiro HIGUCHI, Tokyo (JP)

(73) Assignee: Takata Corporation, Tokyo (JP)

(21) Appl. No.: 14/796,666

(22) Filed: Jul. 10, 2015

(30) Foreign Application Priority Data
Jul. 29, 2014 (JP) 2014-154094

(51) Int. Cl. B60R 22/02; B60R 22/347; B60R 22/20

(52) U.S. Cl. CPC B60R 22/023; B60R 22/201; B60R 22/347; B60R 2022/3475

(57) ABSTRACT

The disclosure discloses a seatbelt apparatus comprising a retractor device enabling one end side of a seatbelt, a belt anchor fixing the seatbelt, a support starting point member supporting one end side of the seatbelt, a tongue movably held by a part of the seatbelt, and a seatbelt buckle disposed opposite to the belt anchor beyond a seat cushion, the seatbelt apparatus being enabled to restrain a passenger by an engagement operation of the tang with the seatbelt buckle, the seatbelt apparatus further comprising a displacement member disposed on the support starting point member to be capable of displacing a start point position of the seatbelt to an initial position and to a moved position close to the shoulder of the passenger, and a drive device displacing the displacement member from the initial position to the moved position.

### BACKGROUND OF THE INVENTION

1. Field of the Invention

The present invention relates to a seatbelt apparatus restraining a passenger.

2. Description of the Related Art

A seatbelt apparatus restraining a passenger is conventionally associated with a wearing operation performed by moving a tongue forward from the vicinity of a shoulder anchor located behind and above the passenger, for example, in the case of a rear seatbelt, while pulling out a seatbelt from a retractor device and by engaging the tongue with a seatbelt buckle.

Since the pullout side of the seatbelt is housed in the retractor device when not in use, if the shoulder anchor is located in a rear pillar of a vehicle body or near a ceiling in the vicinity thereof, the tongue can be located in the vicinity of the shoulder anchor so as to improve operability when a passenger holding the tongue pulls out the seatbelt and engages the tongues with the seatbelt buckle (see, e.g., JP, A, 2010-159000, JP, A, 2010-179705).

On the other hand, by placing the retractor device on an upper surface of a rear parcel shelf etc. or disposing a through anchor at an upper end of a rear seat back, a pullout position of the seatbelt can be located near a shoulder of a passenger.

As a result, a pullout starting end portion of the seatbelt can be made closer to a passenger's shoulder to improve a restraining performance for the passenger (see, e.g., JP, A, 2011-063226).

### SUMMARY OF THE INVENTION

In the prior arts described above, for example, if a tongue is located in the vicinity of a shoulder anchor, the operability is improved; however, the upper end of the seatbelt is located at the position of the shoulder anchor and is away from a passenger's shoulder.

On the other hand, if a through anchor is disposed on a rear seat back, the tongue is located in the vicinity of the through anchor when not in used and therefore becomes too close to the passenger's shoulder, which reduces the operability at the time of holing the tongue to pull out the seatbelt.

To optimize a seatbelt apparatus in such a configuration, it is desirable to enhance both the operability when a passenger wears a seatbelt and the restraining performance for a passenger.

It is an object of the present invention to provide a seatbelt apparatus capable of improving the operability when a passenger wears a seatbelt and the restraining performance for a passenger.

### Means for Solving the Problem

In order to achieve the above-described object, according to the present invention, there is provided a seatbelt apparatus comprising a retractor device enabling one end side of a seatbelt to be wound and pulled out, a belt anchor fixing the other end of the seatbelt, a support starting point member supporting the one end side of the seatbelt, a tongue movably held by a part of the seatbelt between the belt anchor and the support starting point member, and a seatbelt buckle disposed opposite to the belt anchor beyond a seat cushion, the seatbelt apparatus being enabled to restrain a passenger by an engagement operation of the tang with the seatbelt buckle while pulling out the seatbelt from the vicinity of the support starting point member, the seatbelt apparatus further comprising a displacement member disposed on the support starting point member to be capable of displacing a start point position of the seatbelt on the one end side to an initial position higher than a shoulder of the passenger and to a moved position close to the shoulder of the passenger, and a drive device displacing the displacement member from the initial position to the moved position.

A seatbelt apparatus of the present invention is a so-called three-point seatbelt apparatus with one end of a seatbelt located at an initial position higher than a shoulder of a passenger when not restraining the passenger, and a belt anchor on the other end side of the seatbelt is fixed to a floor surface etc.

To restrain a passenger by the seatbelt, a tongue located in the vicinity of the initial position is pulled toward the passenger to pull out the seatbelt from a retractor device and the tongue is engaged with a seatbelt buckle disposed on the opposite side of the passenger so as to restrain the passenger.

The seatbelt device of the present invention has a displacement member disposed on a support starting point member and capable of displacing a start point position of the seatbelt on the one end side to an initial position higher than a shoulder of a passenger and to a moved position close to the shoulder of the passenger. The displacement member can be displaced by a drive device from the initial position to the moved position.

As a result, when a passenger wears the seatbelt, the start point position of the seatbelt on the one end side is located at the initial position higher than the shoulder of a passenger and the operability can be improved. When the passenger is restrained, the start point position can be displaced to the moved position close to the shoulder of the passenger by drive of the drive device, thereby improving the restraining performance for the passenger.

Further, according to the present invention, the seatbelt apparatus further comprises an actuation device actuating the drive device when shock is applied to a vehicle body.

As a result, after a passenger is restrained and before shock is applied to a vehicle body, the operability can be ensured at the time of release of the restraint by the seatbelt such as when the passenger gets off, while the restraining performance can be improved when shock is applied to the vehicle body.

Further, according to the present invention, in the seatbelt apparatus, the support starting point member includes a guide rail extending along a vertical direction of a vehicle body, a slider as the displacement member, that is guided by the guide rail, a tension member connected between the slider and the drive device, and a shoulder anchor disposed on the slider to fold the one end side of the seatbelt.

In particular, the support starting point member has a slider displaced to the initial position and the moved position through a guide rail disposed on a vehicle body pillar etc., and extending in a vertical direction of the vehicle body. Therefore, by pulling the slider by the drive device, a shoulder anchor can be displaced from the initial position higher than the shoulder of the passenger to the moved position close to the shoulder of the passenger.

Further, according to the present invention, in the seatbelt apparatus, the guide rail has a positioning portion positioning the slider at the initial position and allowing the slider to be displaced to the moved position by a drive force of the drive device.

As a result, an actuation member is located at the initial position when the seatbelt is not in use or is worn by a passenger during the normal time, and can be displaced to the moved position only when the drive device is actuated.

Here, according to the present invention, in the seatbelt apparatus, the support starting point member is a shoulder anchor folding the one end side of the seatbelt, and the drive device is an actuation member capable of being at least extended or contracted with the shoulder anchor fixed to one end of the actuation member.

As a result, the shoulder anchor can directly be displaced to the initial position and the moved position. Therefore, this makes it easy to cope with, for example, a seatbelt apparatus of a type having the one end side of the seatbelt pulled out from a ceiling etc., rather than having the one end side of the seatbelt pulled out from a vehicle body pillar, and the versatility can be improved.

Further, according to the present invention, in the seatbelt apparatus, the support starting point member is a through anchor disposed on the retractor device, and the drive device is an actuation member capable of being at least extended or contracted with the retractor device fixed to be displaceable at least either between an elevated position and a lowered position or between the outer side and the inner side of the vehicle body.

As a result, the retractor device can directly be displaced to the initial position and the moved position. Therefore, this makes it easy to cope with, for example, a seatbelt apparatus having the retractor device disposed on a vehicle tonneau board etc., and the versatility can be improved.

### ADVANTAGE OF THE INVENTION

The present invention can improve the operability when a passenger wears a seatbelt and the restraining performance for the passenger.

### BRIEF DESCRIPTION OF DRAWINGS

FIG. 1 is a general explanatory view of an internal configuration of a vehicle body, showing a first embodiment of a seatbelt apparatus of the present invention.

FIG. 2 is a perspective view of the seatbelt apparatus, showing the first embodiment of the seatbelt apparatus of the present invention.

FIG. 3 is a general explanatory view of a support starting point member, showing the first embodiment of the seatbelt apparatus of the present invention.

FIG. 4 is a functional block diagram of an actuation device, showing the first embodiment of the seatbelt apparatus of the present invention.

FIG. 5A is an explanatory view of an example of a positioning portion, showing the first embodiment of the seatbelt apparatus of the present invention.

FIG. 5B is an explanatory view of another example of the positioning portion, showing the first embodiment of the seatbelt apparatus of the present invention.

FIG. 6A is a front view of a passenger wearing a seatbelt, showing the first embodiment of the seatbelt apparatus of the present invention.

FIG. 6B is a side view of the passenger wearing the seatbelt, showing the first embodiment of the seatbelt apparatus of the present invention.

FIG. 7 is a general explanatory view of an internal configuration of a vehicle body, showing a third embodiment of the seatbelt apparatus of the present invention.

FIG. 8 is a perspective view of the seatbelt apparatus, showing the third embodiment of the seatbelt apparatus of the present invention.

FIG. 9A is a perspective view of a rear sheet, showing a fourth embodiment of the seatbelt apparatus of the present invention.

FIG. 9B is a plane view of the support starting point member, showing the fourth embodiment of the seatbelt apparatus of the present invention.

FIG. 9C is a front view of the support starting point member, showing the fourth embodiment of the seatbelt apparatus of the present invention.

### DETAILED DESCRIPTION OF THE PREFERRED EMBODIMENTS

A first embodiment of the present invention will now be described with reference to the drawings. In the following description, longitudinal/lateral directions of a vehicle body refer to longitudinal/lateral directions from the viewpoint of a seated passenger.

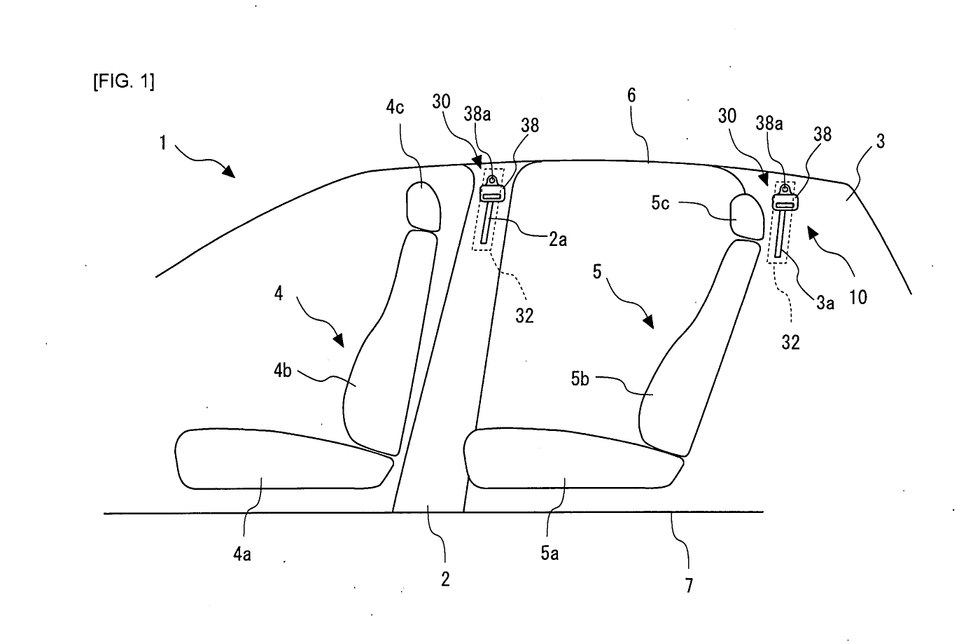

In FIG. 1, a vehicle body 1 comprises a center pillar 2 disposed at the center in the longitudinal direction of the vehicle body 1 and extending in the vertical direction of the vehicle body 1, a rear pillar 3 disposed near the rear in the longitudinal direction of the vehicle body 1 and extending in the vertical direction of the vehicle body 1, a front seat 4 disposed closer to the front of the vehicle body 1 as compared to the center pillar 2, a rear seat 5 disposed between the center pillar 2 and the rear pillar 3, and a vehicle body roof 6, and a vehicle body floor 7.

The center pillar 2 and the rear pillar 3 are disposed with front-seat and rear-seat seatbelt apparatuses 10 partially shown in FIG. 1.

The front seat 4 has a front seat cushion 4a, a front seat back 4b, and a front headrest 4c.

The rear seat 5 has a rear seat cushion 5a, a rear seat back 5b, and a rear headrest 5c.

Since the front-seat and rear-seat seatbelt apparatuses 10 have substantially the same main configurations, the rear-seat seatbelt apparatus 10 will be described in the following description.

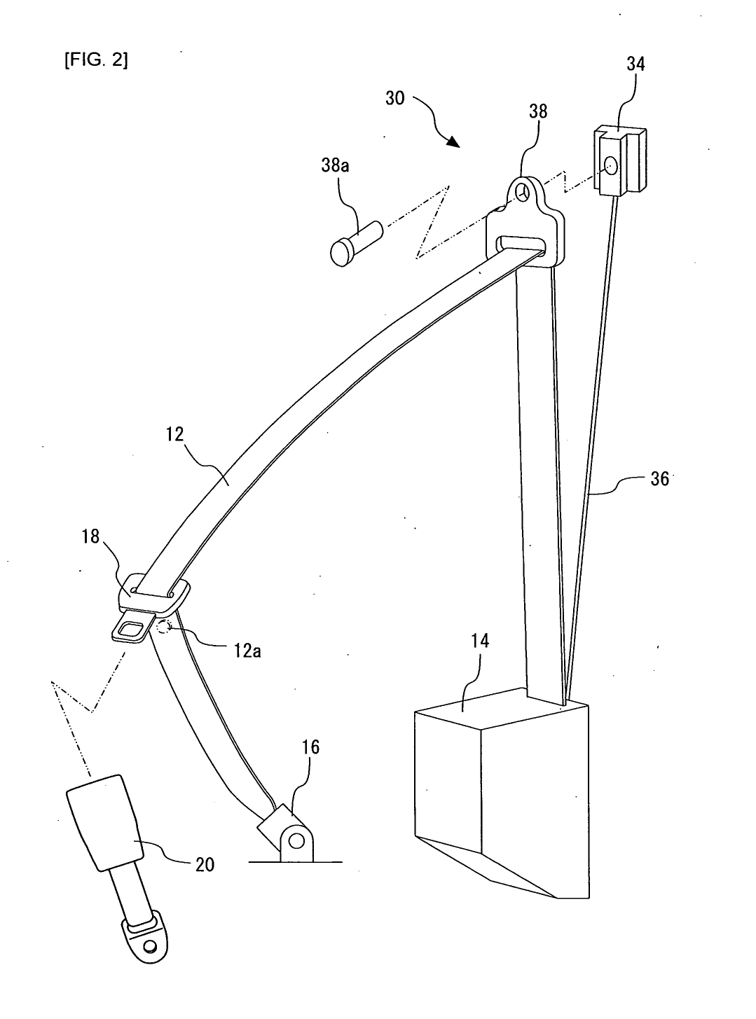

As shown in FIG. 2, the seatbelt apparatus 10 comprises a seatbelt 12, a retractor device 14 enabling the seatbelt 12 to be wound and pulled out on one end side, a belt anchor 16 fixing the other end of the seatbelt 12, a support starting point member 30 supporting the seatbelt 12 on the one end side, a tongue 18 movably held by a portion of the seatbelt 12 between the belt anchor 16 and the support starting point member 30, and a seatbelt buckle 20 disposed at a position across the seat cushion from the belt anchor 16.

The seatbelt 12 is made up of a belt-shaped cloth and has a known configuration. The seatbelt 12 goes from the retractor device 14 fixed to the lower end of the rear pillar 3 etc., though the inside of the rear pillar 3 from the lower side toward the upper side of the vehicle body 1 and is then led out from a position on the upper side of the vehicle body 1 into the interior of the vehicle body 1.

For the retractor device 14, a known device is used. This apparatus used for the retractor device 14 comprises a pretensioner as a drive device actuated for winding the seatbelt 12 on the one end side when shock is applied to the vehicle body 1.

The belt anchor 16 is fixed to the vehicle body floor 7 or a seat rail etc. not shown supporting the rear seat cushion 5a such that the rear seat cushion 5a can be displaced in the longitudinal direction of the vehicle body 1.

The tongue 18 is located near an initial position on the upper side of the vehicle body 1 when the seatbelt 12 is not in use, and is prevented by a stopper 12a disposed on the seatbelt 12 from being displaced further toward the other end of the seatbelt 12.

The seatbelt buckle 20 has a known configuration and is rotatably supported by a cushion frame not shown such that the seatbelt buckle 20 is partially embedded in the rear seat cushion 5a on the opposite side across the rear seat cushion 5a for one passenger from the belt anchor 16.

As a result, when a passenger grasping the tang 18 performs an engagement operation with the seatbelt buckle 20 while pulling out the seatbelt 12 from the vicinity of the support starting point member 30, the seatbelt apparatus 10 is enabled to restrain the passenger.

The support starting point member 30 comprises a guide rail 32 extending in the vertical direction of the vehicle body 1 as shown in FIG. 1, a slider 34 acting as a displacement member guided by the guide rail 32 as shown in FIG. 3, a wire 36 acting as a tension member connected between the slider 34 and the drive device (pretensioner) of the retractor device 14, and a shoulder anchor 38 disposed on the slider 34 to fold the seatbelt 12 on the one end side.

The guide rail 32 is located near the upper portion of the vehicle body 1 and is fixed to the inside of the rear pillar 3 along the vertical direction of the vehicle body 1. The guide rail 32 may be an extrusion-molded product made of metal and has a groove shape opened toward the inside of the vehicle body 1 when fixed to the rear pillar 3.

The slider 34 is a block body made of metal or hard resin and is displaced inside the guide rail 32 with a portion exposed inside the vehicle body from the opening of the guide rail 32 when mounted on the guide rail 32. As a result, for example, the slider 34 is displaced such that a position near the upper end of the guide rail 32 is defined as an initial position higher than a shoulder of a passenger while a position near the lower end of the guide rail 32 is defined as a moved position close to the shoulder of the passenger.

The wire 36 has an upper end connected to the slider 34 and a lower end connected to the drive device (pretensioner) of the retractor device 14. The drive device of the retractor device 14 is arranged such that the wire 36 is not pulled out or wound when the seatbelt 12 is pulled out and when the seatbelt 12 is normally wound.

The shoulder anchor 38 also acts as a start point position of the seatbelt extending upward from the lower side of the vehicle body 1 and going downward again to the belt anchor 16 on the lower side of the vehicle body 1. Therefore, the start point position is changed depending on a position of the shoulder anchor 38. As shown in FIG. 2, the shoulder anchor 38 is fixed to the slider 34 by a fixing member 38a such as a screw. Therefore, the rear pillar 3 has a guide groove 3a formed along the guide rail 32. The center pillar 2 also has a guide groove 2a formed along the guide rail 32.

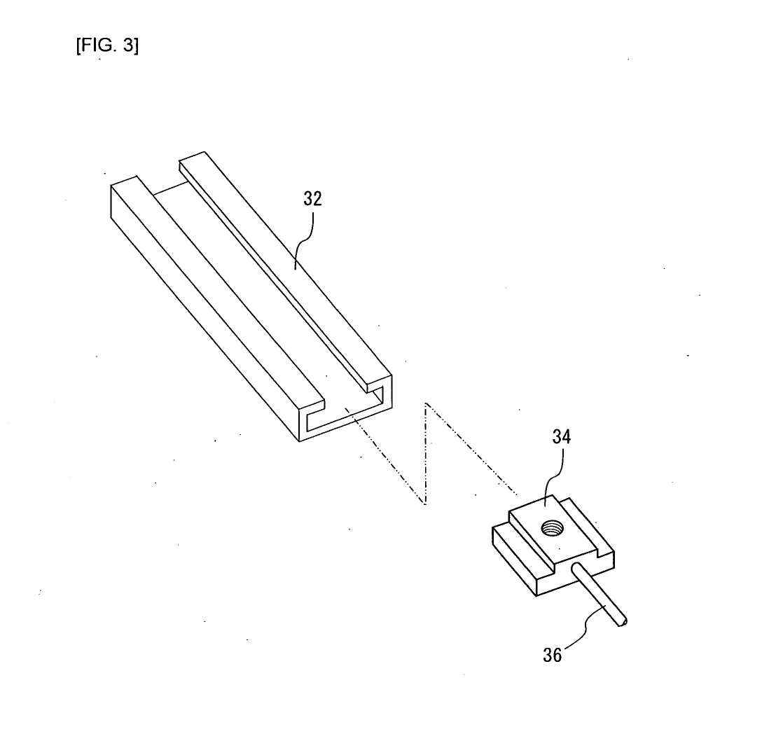

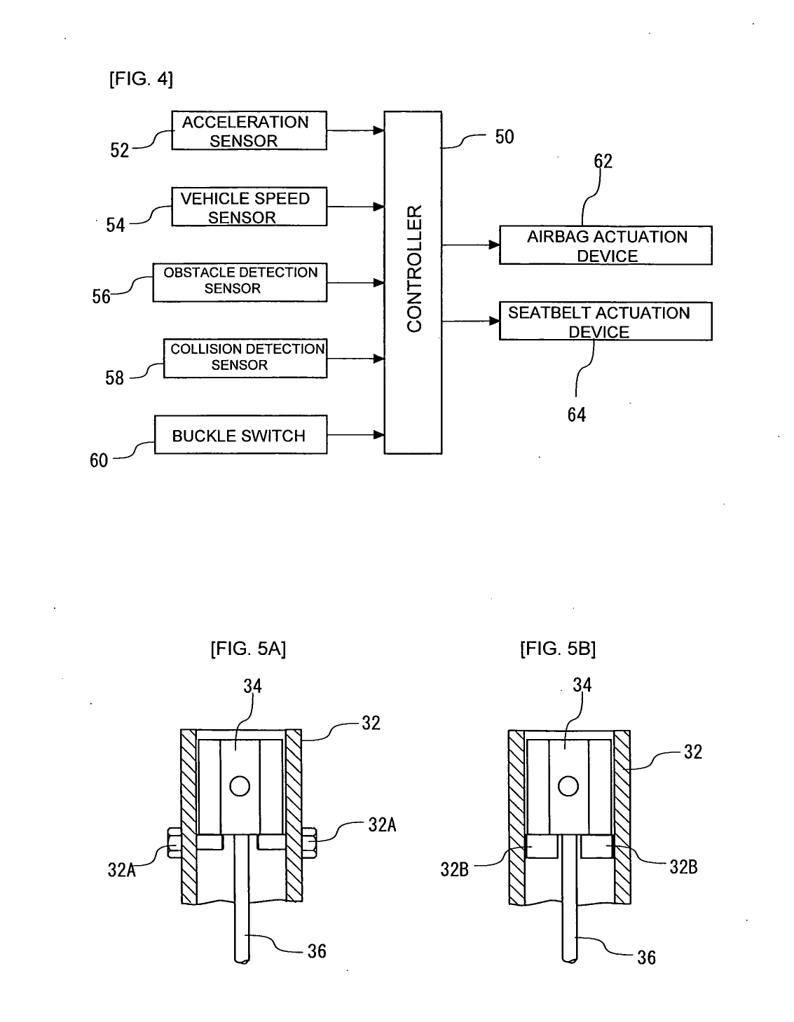

On the other hand, as shown in FIG. 4, the seatbelt apparatus 10 can be controlled by a controller (ECU) 50 shared with an airbag apparatus not shown, for example. To the controller 50, output signals are input from an acceleration sensor 52, a vehicle speed sensor 54, an obstacle detection sensor 56, and a collision detection sensor 58, as well as from a buckle switch 60 detecting that the tongue 18 is fitted to the seatbelt buckle 20. This allows the controller 50 to actuate an airbag actuation device 62 and a seatbelt actuation device 64 acting as an actuation device, when collision of the vehicle body 1 occurs.

In particular, when shock is applied to the vehicle body 1 due to collision etc., the controller 50 actuates the airbag actuation device 62 to actuate an inflator of the airbag apparatus. When shock is applied to the vehicle body 1 due to collision etc., the controller 50 also actuates the seatbelt actuation device 64 to drive the drive device of the retractor device 14, thereby winding the seatbelt 12 and pulling in the wire 36.

As a result, the slider 34 is displaced along the guide rail 32 from the initial position to the moved position. Since the displacement of the slider 34 loosens the seatbelt 12, the drive device needs the pretensioner for the retractor device 14 (or the seatbelt buckle 20) to eliminate a belt slack.

The displacement of the slider 34 due to self-weight from the initial position to the moved position is prevented by a positioning portion such as bolt-shaped pins 32A made of resin penetrating the guide rail 32 as shown in FIG. 5A and stoppers 32B affixed to the guide rail 32 as shown in FIG. 5B, for example.

As described above, the guide rail 32 positions the slider 34 at the initial position and allows the slider 34 to be displaced to the moved position by a drive force of the drive device.

The slider 34 is located at the initial position when the seatbelt is not in use or is worn by a passenger during the normal time, and the slider 34 can be displaced to the moved position only when the drive device is actuated. Therefore, the pulling force of the drive device and the rigidity of the slider 34 are set higher than the strength of the pins 32A and higher than a sticking force of the stoppers 32B.

Alternatively, the slider 34 may be kept at the initial position by, for example, a spring pulling up the slider 34 with a pulling force lower than that of the drive device or a protrusion formed by cutting and raising or punching disposed on the guide rail 32, instead of the pins 32A and the stoppers 32B.

The pretensioner acting as the drive device may be disposed on the seatbelt buckle 20 instead of the retractor device 14.

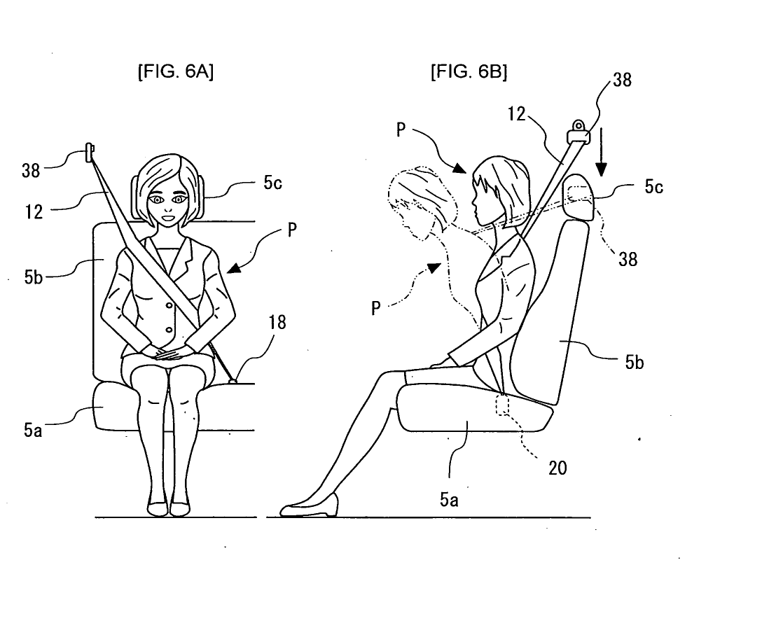

When a passenger P is restrained by the seatbelt 12 as shown in FIGS. 6A and 6B in the configuration described above, the tongue 18 located in the vicinity of the initial position is pulled toward the passenger P to pull out the seatbelt 12 from the retractor device 14 and the tongue 18 is engaged with the seatbelt buckle 20 disposed on the opposite side of the passenger P so as to restrain the passenger P.

The seatbelt device 10 of the present invention has the slider 34 disposed on the support starting point member 30 and capable of displacing the start point position of the seatbelt 12 on the one end side to the initial position higher than a shoulder of the passenger P and to the moved position close to the shoulder of the passenger P. The slider 34 can be displaced by the drive device from the initial position to the moved position.

As a result, when the passenger P wears the seatbelt 12, the start point position of the seatbelt 12 on the one end side is located at the initial position higher than the shoulder of the passenger P and the operability can be improved.

Additionally, the seatbelt apparatus 10 comprises the seatbelt actuation device 64 actuating the drive device when shock is applied to the vehicle body 1 and, therefore, after the passenger P is restrained and before shock is applied to the vehicle body 1, the operability can be ensured at the time of release of the restraint by the seatbelt 12 such as when the passenger gets off, while the restraining performance can be improved when shock is applied to the vehicle body 1.

Although the first embodiment discloses that the seatbelt 12 is pulled out from the rear pillar 3 on one end side and that the displacement member is the slider 34 capable of displacing the start point position corresponding to the shoulder anchor 38 to the initial position higher than the shoulder of the passenger P and to the moved position close to the shoulder of the passenger P, this is not a limitation.

### Second Embodiment

For example, the support starting point member 30 may be eliminated such that the shoulder anchor 38 folding the seatbelt 12 on the one end side also acts as the support starting point member, and the drive device may be an actuation member such as a solenoid and an electromagnetic spring capable of being at least extended or contracted with the shoulder anchor 38 fixed to one end thereof such that the actuation member is driven by the seatbelt actuation device 64.

As a result, the shoulder anchor 38 can directly be displaced to the initial position and the moved position. Therefore, this makes it easy to cope with, for example, a seatbelt apparatus of a type having the one end side of the seatbelt 12 pulled out from a ceiling etc., rather than having the one end side of the seatbelt 12 pulled out from the rear pillar 3, and the versatility can be improved.

### Third Embodiment

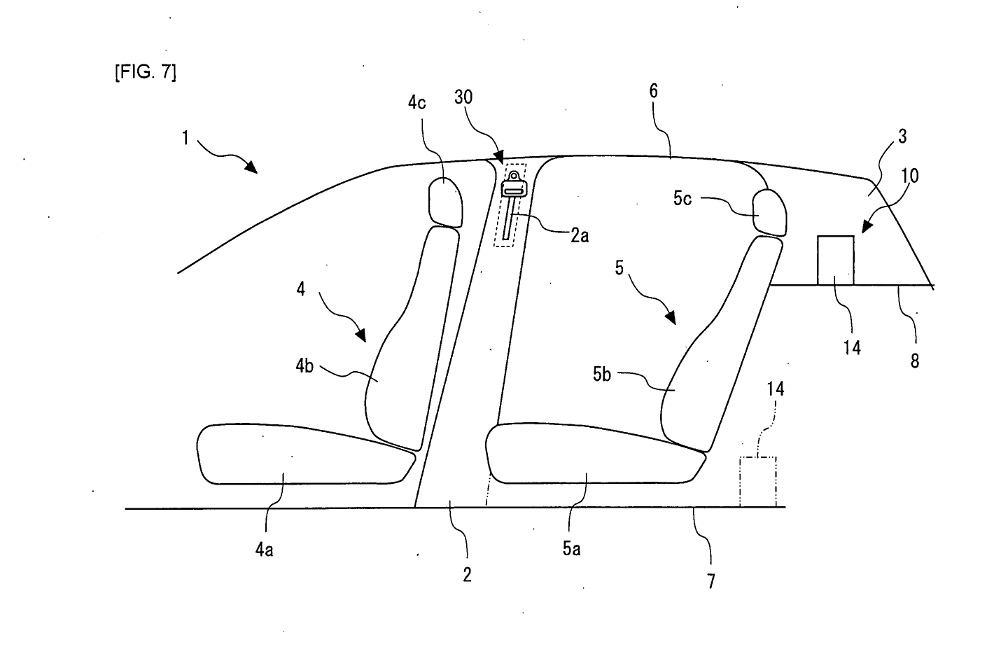

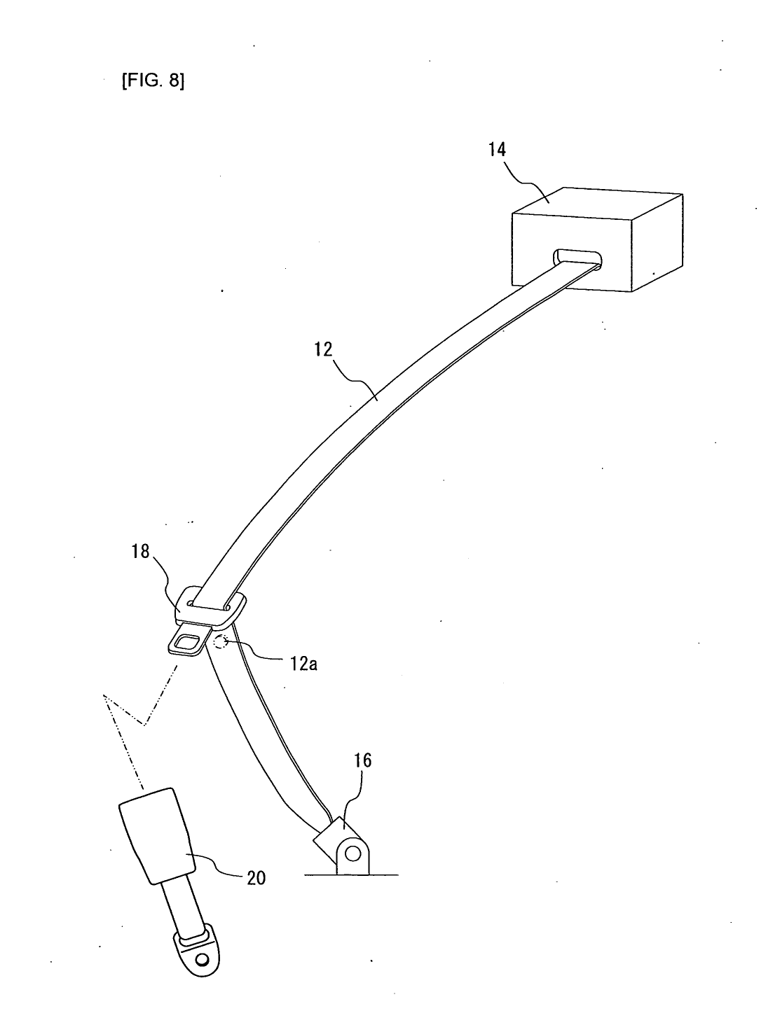

As shown in FIGS. 7 and 8, the support starting point member 30 may be eliminated such that the retractor device 14 with the one end side of the seatbelt 12 pulled out from a through anchor (not shown) is disposed on a vehicle tonneau board 8 disposed behind the rear seat 5, and the drive device may be a solenoid etc. acting as an actuation member capable of being at least extended or contracted with the retractor device 14 fixed to be displaceable at least either between an elevated position and a lowered position or between the outer side and the inner side of the vehicle body.

As a result, the retractor device 14 can directly be displaced to the initial position and the moved position. Therefore, this makes it easy to cope with, for example, a seatbelt apparatus having the retractor device 14 disposed on the vehicle tonneau board 8 etc., and the versatility can be improved.

### Fourth Embodiment

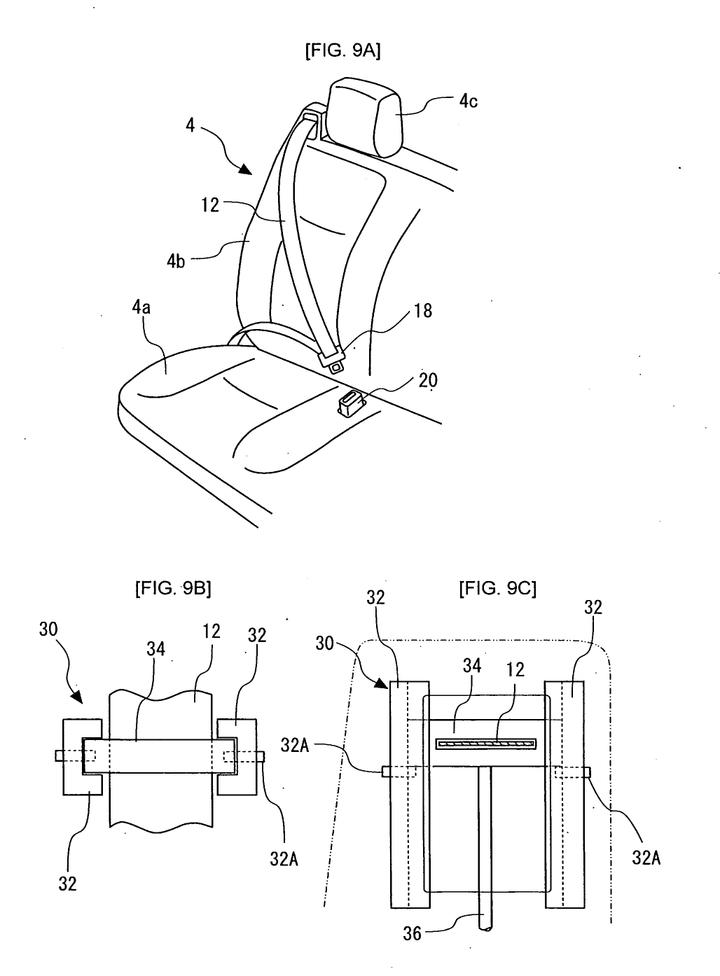

As shown in FIG. 9A, if the retractor device 14 is disposed on the vehicle tonneau board 8 or the vehicle body floor 7, the support starting point member 30 may be disposed on the rear seat back 5b.

### Other Modification Examples

Although a force of restraining the passenger P is increased when shock is applied to the vehicle body 1 in the configurations disclosed in the embodiments described above, the initial position can be changed separately from the moved position.

For example, if the passenger P is a small woman or a child, the initial position is desirably at the height corresponding to a body size of the passenger P. Particularly in the case of a child, the difficulty to reach the tang 18 is also a problem.

Therefore, in such a case, for example, cut-and-raised positioning portions can be formed at a plurality of positions on the guide rail 32 so that the position of the slider 34 can be made lower and higher to change the initial position. The initial position can be changed also in the third and fourth embodiments.

The obstacle detection sensor 56 may be a millimeter wave radar predicting a collision before the actual collision, for example, and the airbag actuation device 62 and the seatbelt actuation device 64 can be actuated at the same time by the controller 50 based on the prediction result.

In this case, the seatbelt actuation device 64 may use a motor retractor, instead of a pretensioner, to pull in the seatbelt 12. The position of the shoulder anchor 38 can also be displaced from the initial position to the moved position by motor drive or displaced to change the initial position.

The present invention is also applicable to a double retractor system (including a pretensioner) in which a retractor device is disposed in the belt anchor 16 on the outer side of the lap along with the retractor 14.

As described above, the seatbelt apparatus 10 of this embodiment comprises the retractor device 14 enabling the seatbelt 12 to be wound and pulled out on one end side, the belt anchor 16 fixing the other end of the seatbelt 12, the support starting point member 30 supporting the seatbelt 12 on the one end side, the tongue 18 movably held by a portion of the seatbelt 12 between the belt anchor 16 and the support starting point member 30, and the seatbelt buckle 20 disposed at a position across the seat cushion from the belt anchor 16; the seatbelt apparatus 10 is enabled to restrain a passenger by an engagement operation of the tang 18 with the seatbelt buckle 20 while pulling out the seatbelt 12 from the vicinity of the support starting point member 30; and the seatbelt apparatus 10 comprises a slider 34 disposed on the support starting point member 30 to be capable of displacing the start point position of the seatbelt 12 on the one end side to the initial position higher than a shoulder of a passenger and to the moved position close to the shoulder of the passenger and the drive device displacing the slider 34 from the initial position to the moved position, thereby improving the operability when the passenger P wears the seatbelt and the restraining performance for the passenger P.

What is claimed is:

1. A seatbelt apparatus comprising:
a retractor device enabling one end side of a seatbelt to be wound and pulled out;
a belt anchor fixing the other end of the seatbelt;
a support starting point member supporting said one end side of said seatbelt;
a tongue movably held by a part of the seatbelt between said belt anchor and said support starting point member; and
a seatbelt buckle disposed opposite to said belt anchor beyond a seat cushion,
the seatbelt apparatus being enabled to restrain a passenger by an engagement operation of said tang with said seatbelt buckle while pulling out said seatbelt from the vicinity of said support starting point member,
the seatbelt apparatus further comprising
a displacement member disposed on said support starting point member to be capable of displacing a start point position of said seatbelt on the one end side to an initial position higher than a shoulder of the passenger and to a moved position close to the shoulder of the passenger, and
a drive device displacing said displacement member from the initial position to the moved position.

2. The seatbelt apparatus according to claim 1, further comprising an actuation device actuating said drive device when shock is applied to a vehicle body.

3. The seatbelt apparatus according to claim 1, wherein
said support starting point member includes:
a guide rail extending along a vertical direction of a vehicle body,
a slider as the displacement member, that is guided by said guide rail;
a tension member connected between said slider and said drive device, and
a shoulder anchor disposed on said slider to fold the one end side of said seatbelt.

4. The seatbelt apparatus according to claim 1, wherein
said guide rail has a positioning portion positioning said slider at the initial position and allowing said slider to be displaced to the moved position by a drive force of said drive device.

5. The seatbelt apparatus according to claim 1, wherein
said support starting point member is a shoulder anchor folding the one end side of the seatbelt, and
said drive device is an actuation member capable of being at least extended or contracted with said shoulder anchor fixed to one end of the actuation member.

6. The seatbelt apparatus according to claim 1, wherein
said support starting point member is a through anchor disposed on said retractor device, and
said drive device is an actuation member capable of being at least extended or contracted with said retractor device fixed to be displaceable at least either between an elevated position and a lowered position or between the outer side and the inner side of the vehicle body.
